(19) United States
(12) Patent Application Publication
(10) Pub. No.: US 2024/0333014 A1
(43) Pub. Date: Oct. 3, 2024

(54) BATTERY PACK TO BATTERY PACK CHARGING

(71) Applicant: MILWAUKEE ELECTRIC TOOL CORPORATION, Brookfield, WI (US)

(72) Inventor: Vishal Meyyappan, Milwaukee, WI (US)

(21) Appl. No.: 18/620,610

(22) Filed: Mar. 28, 2024

Related U.S. Application Data
(60) Provisional application No. 63/492,822, filed on Mar. 29, 2023.

(51) Int. Cl. H02J 7/00; H01M 10/42; H01M 10/44; H01M 50/247

(52) U.S. Cl. CPC H02J 7/007182; H01M 10/441; H01M 50/247; H02J 7/0063; H01M 2010/4278; H02J 2207/20; H02J 2207/30

(57) ABSTRACT

A power tool battery pack that includes a housing, a plurality of battery cells supported within the housing, a tool terminal disposed on the housing and electrically connected to the plurality of battery cells, a voltage output port electrically connected to the plurality of battery cells, a voltage converter configured to receive power from the plurality of battery cells to output power port, and an electronic controller. The controller is operable to determine whether the voltage output is electrically connected to an external load, determine a load voltage associated with the external load, determine whether a voltage of the plurality of battery cells is greater than or equal to load voltage, and transfer power from the plurality of battery cells when the voltage of the plurality of battery cells is greater than or equal to the load voltage.

### RELATED APPLICATIONS

This application claims the benefit of U.S. Provisional Patent Application No. 63/492,822, filed Mar. 29, 2023, the entire content of which is incorporated herein by reference.

### SUMMARY

Embodiments described herein provide a wired adapter connectable with a source battery pack and a load battery pack. The wired adapter includes a source port connectable to the source battery pack and configured to receive power from the source battery pack, a load port connectable to the load battery pack and configured to output a charging current to charge the load battery pack, a voltage converter configured to receive power from the source port and to output the charging current to the load port, and an electronic controller. The electronic controller is configured to determine whether the source battery pack is connected to the wired adapter, determine whether the load battery is connected to the wired adapter, determine a source voltage associated with the source battery pack, determine a load voltage associated with the source battery pack, determine whether the source voltage is greater than or equal to the load voltage, and transfer power from the source battery pack to the load battery pack when the source voltage is greater than or equal to the load voltage.

Embodiments described herein provide a power tool battery pack. The battery pack includes a housing, a plurality of battery cells supported within the housing, a tool terminal disposed on the housing and electrically connected to the plurality of battery cells, a voltage output port electrically connected to the plurality of battery cells, a voltage converter configured to receive power from the plurality of battery cells to output power to the voltage output port, and an electronic controller. The controller is configured to determine whether the voltage output port is electrically connected to an external load, determine a load voltage associated with the external load, determine whether a voltage of the plurality of battery cells is greater than or equal to the load voltage, and transfer power from the plurality of battery cells when the voltage of the plurality of battery cells is greater than or equal to the load voltage.

Embodiments described herein provide a power tool battery pack. The battery pack includes a housing including an interface configured to connect to a power tool, a plurality of battery cells supported within the housing, a source transceiver electrically connected to the plurality of battery cells and configured to wirelessly transfer power to an external device, and an electronic controller connected to the transceiver. The electronic controller is configured to determine whether the source transceiver is within a power transfer range of a load transceiver of the external device, determine a voltage of the plurality of battery cells, determine a required voltage for charging the external device, and transfer power from the source transceiver to the load transceiver if the voltage of the plurality of battery cells is greater than or equal to the required voltage for charging the external device.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIGS. 1A, 1B, and 1C illustrate battery packs, according to embodiments described herein.

FIG. 2 illustrates a control system for the battery packs of FIGS. 1A-1C, according to embodiments described herein.

FIG. 3A illustrates a battery adapter, according to embodiments described herein.

FIG. 3B illustrates a control system for the battery adapter of FIG. 3A, according to embodiments described herein.

FIG. 4 illustrates a wireless communication controller for the battery packs of FIGS. 1A-1C or the battery adapter of FIG. 3A, according to embodiments described herein.

FIG. 5 illustrates a communication network for the battery packs of FIGS. 1A-1C or the battery adapter of FIG. 3A, according to embodiments described herein.

FIG. 6 illustrates an interface for controlling the battery packs of FIGS. 1A-1C or the battery adapter of FIG. 3A, according to embodiments described therein.

FIG. 7 is a flowchart for operating the battery adapter of FIG. 3A, according to embodiments described herein.

FIG. 8 illustrates a wireless charging system, according to embodiments described herein.

FIG. 9 is a flowchart illustrating a method for controlling a wireless charging system of FIG. 8, according to embodiments described herein.

FIG. 10 illustrates a wireless charging system, according to embodiments described herein.

FIG. 11 is a flowchart illustrating a method for controlling the wireless charging system of FIG. 10, according to embodiments described herein.

### DETAILED DESCRIPTION

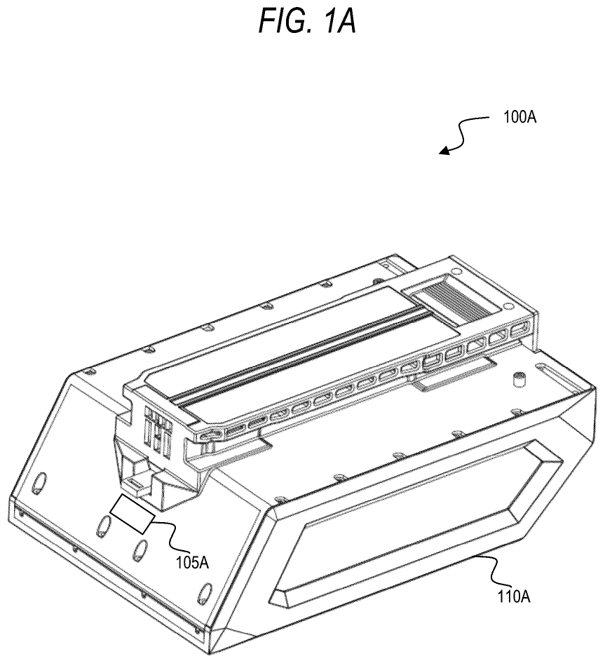

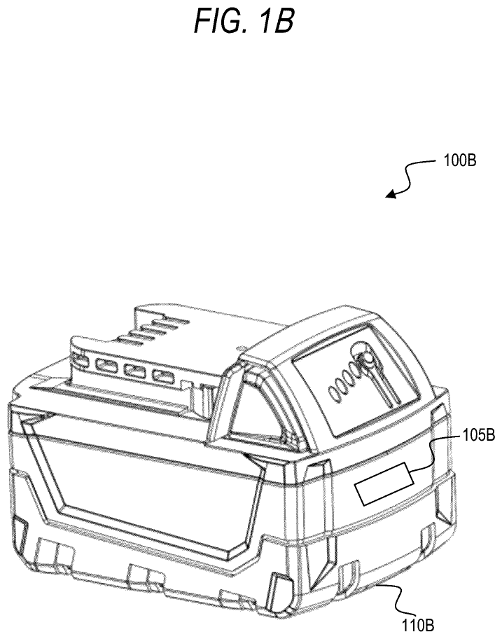

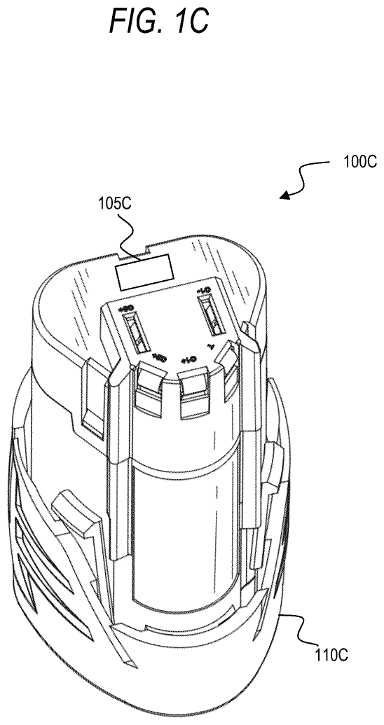

FIGS. 1A, 1B, and 1C each illustrate an exemplary battery pack 100A, 100B, 100C. Each battery packs 100A, 100B, 100C may be usable with various motorized and non-motorized devices (referred to as a “device”). The battery packs 100A, 100B, 100C may be used to power tools (e.g., a drill, a pipe cutter, an impact driver, a saw, a vacuum, etc.). The battery packs 100A, 100B, 100C may also be usable with non-motorized devices, such as sensing devices (e.g., a visual inspection camera, an infrared sensor [such as a thermometer or thermal imaging camera], a clamp-type multimeter, a wall scanner [e.g., a “stud finder”], etc.), lighting devices (e.g., a flashlight, a floodlight, etc.), audio devices (e.g., a radio, a speaker, etc.), a temperature-controlled (e.g., heated and/or cooled) garment, etc.

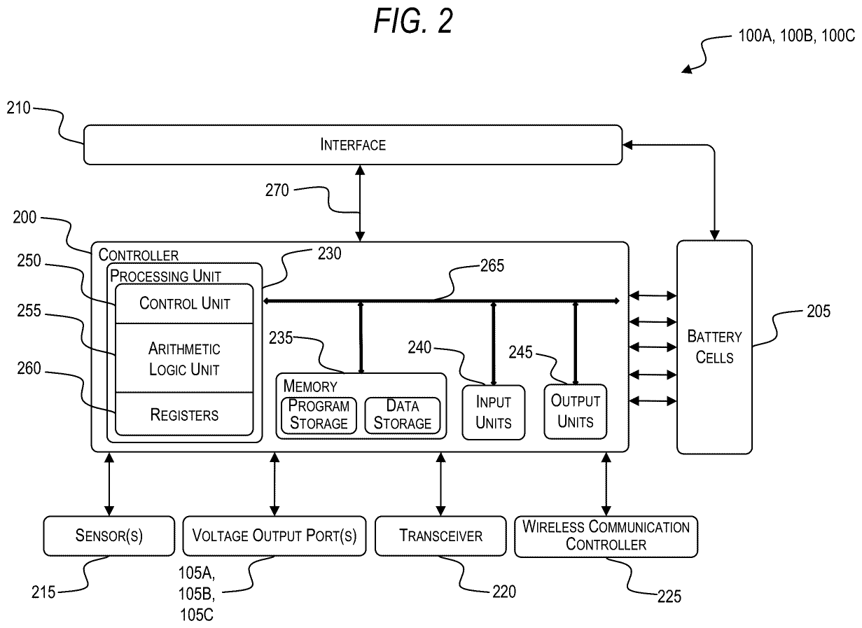

As described in more detail below, the illustrated battery packs 100A, 100B, 100C each include one or more voltage ports 105A, 105B, 105C. The voltage ports 105A, 105B, 105C allow power to transfer between the battery pack 100A, 100B, 100C and an external device or another of the battery packs 100A, 100B, 100C (e.g., directly or indirectly). In some embodiments, the illustrated battery packs 100A, 100B, 100C may also include a wireless transceiver (see FIG. 2) configured to wireless transfer power to an external device or another of the battery packs 100A, 100B, 100C. In some embodiments, the illustrated battery packs 100A, 100B, 100C may also include a wireless communication controller (see FIG. 2) configured to wirelessly communicate with an external device. The battery packs 100A, 100B, and 100C, also include a housing 110A, 110B, 110C to substantially enclose the battery packs 100A, 100B, 100C and house a plurality of battery cells (see FIG. 2).

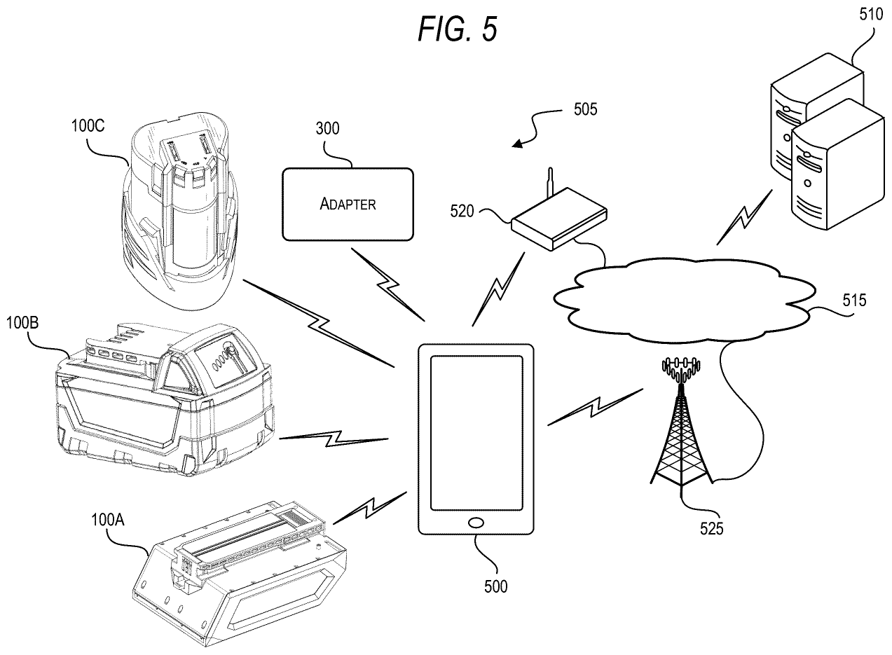

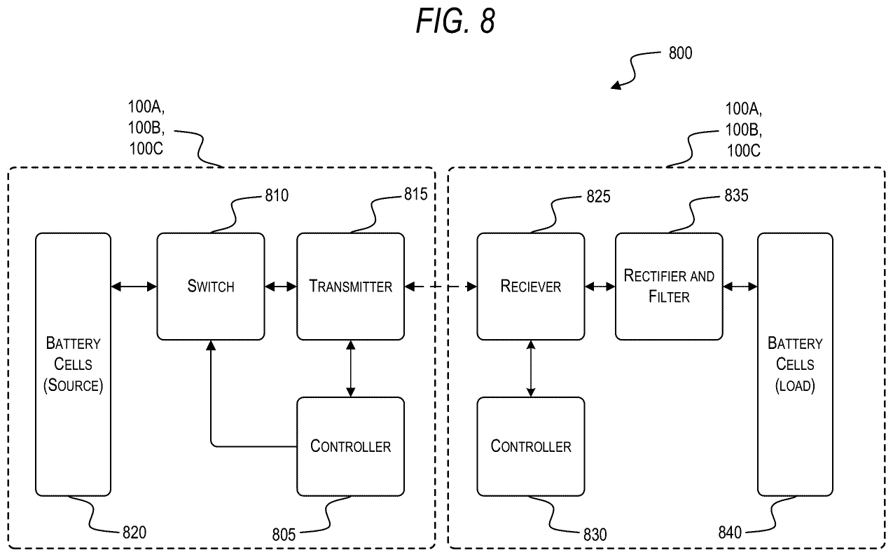

FIG. 2 illustrates a block diagram of the control system for the battery packs 100A, 100B, 100C. The control system includes a controller 200 that is electrically and/or communicatively connected to a variety of modules or components of the battery pack 100A, 100B, 100C. For example, the illustrated controller 200 is connected to one or more battery cells 205 (e.g., lithium-based battery cells) and an interface 210. The controller 200 is also connected to one or more sensors 215 including one or more voltage sensors or voltage sensing circuits, one or more current sensors or current sensing circuits, and one or more temperature sensors or temperature sensing circuits. Additionally, the controller 200 is connected to one or more voltage ports 105A, 105B, 105C configured to transfer power through a wired connection. The voltage ports 105A, 105B, and 105C can function as bi-directional ports having a known interface (e.g., USB-C) or a proprietary interface. The controller 200 may also include a transceiver 220 configured to wirelessly transfer power to an external transceiver (see FIG. 8). The controller 200 may also be connected to a wireless communication controller 225 to allow wireless interfacing between the battery pack 100A, 100B, 100C and an external device (see FIG. 5).

The controller 200 includes combinations of hardware and software that are operable to, among other things, control the operation of the battery packs 100A, 100B, 100C, control the operation of the voltage ports 105A, 105B, 105C, control the operation of the transceiver 220, control the operation of the wireless communication controller 225, monitor a condition of the battery packs 100A, 100B, 100C, enable or disable charging of the battery packs 100A, 100B, 100C, and enable or disable discharging of the battery packs 100A, 100B, 100C, etc.

The controller 200 includes a plurality of electrical and electronic components that provide power, operational control, and protection to the components and modules within the controller 200 and/or the battery packs 100A, 100B, 100C. For example, the controller 200 includes, among other things, a processing unit 230 (e.g., a microprocessor, a microcontroller, an electronic processor, an electronic controller, or another suitable programmable device), a memory 235, input units 240, and output units 245. The processing unit 230 includes, among other things, a control unit 250, an arithmetic logic unit (“ALU”) 255, and a plurality of registers 260 (shown as a group of registers in FIG. 2), and is implemented using a known computer architecture (e.g., a modified Harvard architecture, a von Neumann architecture, etc.). The processing unit 230, the memory 235, the input units 240, and the output units 245, as well as the various modules or circuits connected to the controller 200 are connected by one or more control and/or data buses (e.g., common bus 265). The control and/or data buses are shown generally in FIG. 2 for illustrative purposes. The use of one or more control and/or data buses for the interconnection between and communication among the various modules, circuits, and components would be known to a person skilled in the art in view of the embodiments described herein.

The memory 235 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 230 is connected to the memory 235 and executes software instructions that are capable of being stored in a RAM of the memory 235 (e.g., during execution), a ROM of the memory 235 (e.g., on a generally permanent basis), or another non-transitory computer readable medium such as another memory or a disc. Software included in the implementation of the battery packs 100A, 100B, 100C is operable to control the operation of the voltage ports 105A, 105B, 105C, operation of the transceiver 220, operation of the wireless communication controller 225, etc., and can be stored in the memory 235 of the controller 200. The software includes, for example, firmware, one or more applications, program data, filters, rules, one or more program modules, and other executable instructions. The controller 200 is configured to retrieve from the memory 235 and execute, among other things, instructions related to the control processes and methods described herein. In other constructions, the controller 200 includes additional, fewer, or different components.

The interface 210 includes a combination of mechanical components (e.g., rails, grooves, latches, etc.) and electrical components (e.g., one or more terminals) configured to and operable for interfacing (e.g., mechanically, electrically, and communicatively connecting) the cells 205 of a battery packs 100A, 100B, 100C with an external device. For example, the interface 210 is configured to receive power through a charging circuit via a power input circuit. The interface 210 is also configured to communicatively connect to the controller 200 via a communications line 270. Accordingly, the controller 200 may control the charging of the battery packs 100A, 100B, 100C through the interface 210. Additionally, the interface 210 is also configured to output power through a discharge circuit. As such, the controller 200 may also control the output of the battery packs 100A, 100B, 100C through the interface 210.

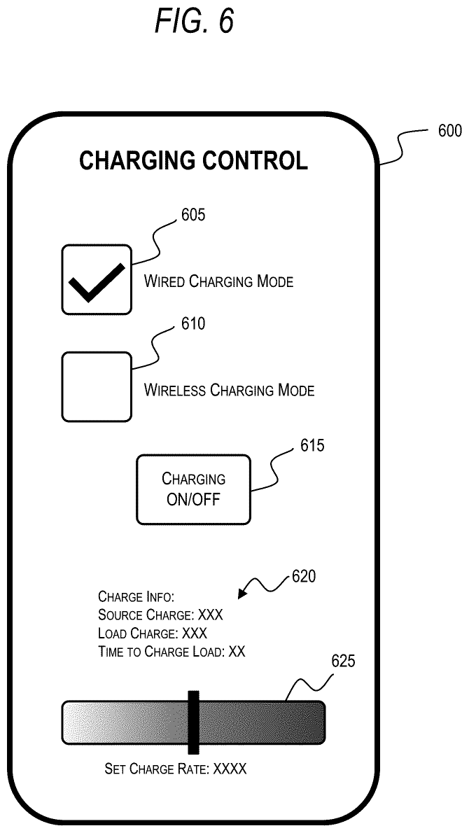

In some embodiments, the controller 200 is configured to control the transfer of power to/from the voltage ports 105A, 105B, 105C. The voltage ports 105A, 105B, 105C may also be configured to communicatively connect the controller 200 to an external device. For example, the controller 200 may receive an input via the wireless communication controller 255 or a user interface (see, e.g., FIG. 6) of an external device of the battery packs 100A, 100B, 100C (e.g., a button, switch, etc.) to enable or prevent power transfer through the interface 210 and direct power to the voltage ports 105A, 105B, 105C.

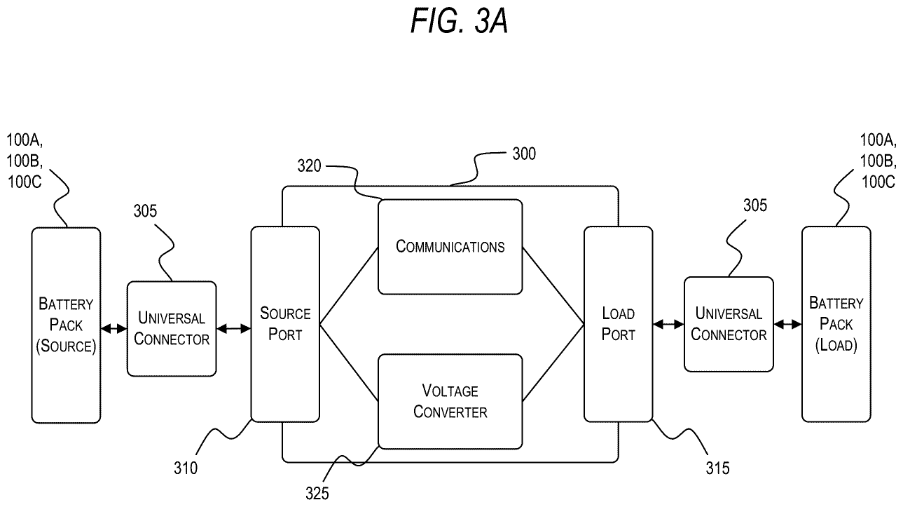

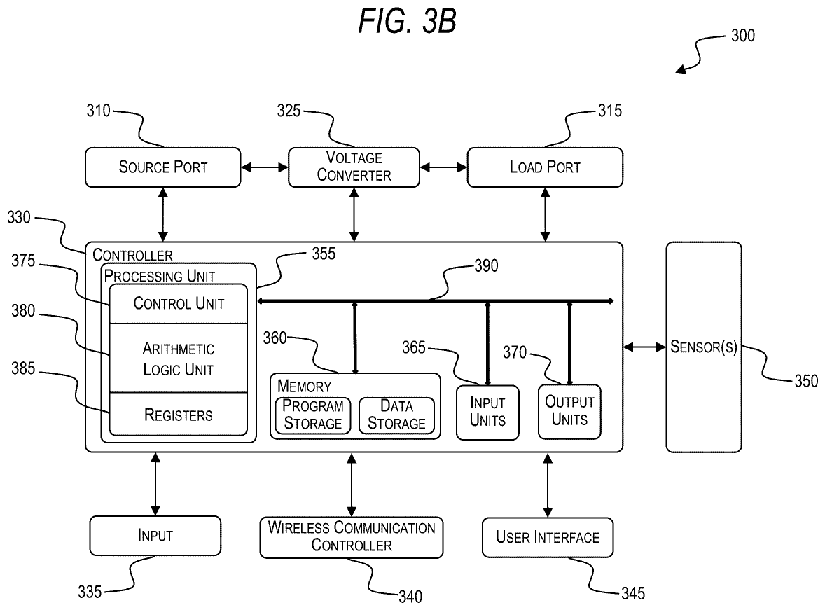

FIG. 3A illustrates a wired adapter 300 configured to transfer power from a source battery pack 100A, 100B, 100C to a load battery pack 100A, 100B, 100C. In some embodiments, the wired adapter 300 electrically connects to the battery packs 100A, 100B, 100C through a universal connector 305 that interfaces with, for example, the voltage ports 105A, 105B, 105C of each respective battery pack. The universal connector 305 is configured to be connectable to a plurality of types of battery packs to facilitate power transfer for a range of voltages (e.g., up to 240 volts). In some embodiments, the universal connector 305 may be a universal serial bus (“USB”) cable (e.g., a USB-C cable). In some embodiments, the universal connector 305 may be a coaxial power connector (e.g., a power jack, a power plug, etc.). In some embodiments, the voltage ports 105A, 105B, 105C output a reduced power output relative to the power output of the battery packs 100A, 100B, 100C to account for power limitations of the universal connector 305. The power reduction to the voltage ports 105A, 105B, 105C may be controlled by the controller 200 of the battery pack 100A, 100B, 100C (e.g., using a step-down converter).

The wired adapter 300 includes a source port 310 configured to electrically connect with the source battery pack 100A, 100B, 100C, and a load port 315 configured to electrically connect with the load battery pack 100A, 100B, 100C. The wired adapter 300 may include a switch or other selector as part of a user interface (see FIG. 3B) to determine which port is the source port 310 and the load port 315. In some embodiments, the wired adapter may have a fixed or dedicated source port 310 and a fixed or dedicated load port 315. The source port 310 and the load port 315 are each configured to connect to a respective universal connector 305. In some embodiments, the universal connector 305 may be fixedly or permanently connected to the source port 310 and load port 315. In other embodiments, the source port 310 and load port 315 may each respectively include an interface to removably connect (e.g., mechanically, electrically, and communicatively connecting) with the universal connector 305. In some embodiments, the source port 310 and the load port 315 may include a plurality of interfaces for one or more types of universal connector 305 (e.g., USB, 12V power jack, etc.). The wired adapter 300 also includes a communications circuit 320 for communicating with an external device, and a voltage converter 325 operable to control the power transfer between the source port 310 and the load port 315.

In some embodiments, the wired adapter 300 may be electrically connected with the source battery pack 100A, 100B, 100C, and/or the load battery pack 100A, 100B, 100C via the interface 210. For example, the universal connector 305 may be removably couplable with the terminals of the battery pack 100A, 100B, 100C. In other constructions, the universal connector 305 includes additional, fewer, or different components.

The communications circuit 320 of the wired adapter 300 is configured to receive data from the controller 200 of the battery packs 100A, 100B, 100C via the universal connector 305. For example, the respective controllers 200 of the battery packs 100A, 100B, 100C electrically connect to the source port 310 and the load port 315 of the wired adapter 300 to communicate with the communications circuit 320 to control the operation of the wireless communication controllers 340, monitor a condition of the source and load battery packs 100A, 100B, 100C, enable or disable charging of the respective load battery packs 100A, 100B, 100C, enable or disable discharging of the respective source battery packs 100A, 100B, 100C, etc.

The voltage converter 325 is configured to receive power from the source port 310 and output a charging current and voltage to the load port 315. In some embodiments, the voltage converter 325 may use an isolated DC-DC converter topology (e.g., a flyback, forward, etc.), or a non-isolated DC-DC converter topology (e.g., a step-down converter, a buck-boost converter, etc.), or a combination of multiple DC-DC conversion topologies.

FIG. 3B illustrates a block diagram of the control system for the wired adapter 300. The control system includes a controller 330 that is electrically and/or communicatively connected to a variety of modules or components of the battery pack 100A, 100B, 100C. For example, the illustrated controller 330 is connected to the source port 310, the load port 315, and the voltage converter 325. The controller 330 is also connected to one or more sensors 350 including one or more voltage sensors or voltage sensing circuits, one or more current sensors or current sensing circuits, and one or more temperature sensors or temperature sensing circuits. Additionally, the controller 330 is connected to a user interface 345 operable by a user to control the wired adapter 300 and monitor the battery packs 100A, 100B, 100C electrically connected via the source port 310 and load port 315. In some embodiments, the user interface 345 includes one or more user inputs (e.g., buttons, switches, etc.) for selecting the source port and the load port. In some embodiments, the wired adapter 300 may include an additional input 335 configured to, for example, receive power from an external power source (e.g., another battery pack, an outlet, etc.). The controller 330 may also be connected to a wireless communication controller 340 to allow wireless interfacing between the battery packs 100A, 100B, 100C and an external device (see FIG. 5).

The controller 330 includes combinations of hardware and software that are operable to adjust the voltage converter 325 to adapt to a range of possible battery packs 100A, 100B, 100C with different voltages. In some embodiments, the controller 330 may adjust the duty cycle and frequency of the voltage converter 325 such that the voltage input into the source port equalizes with the required charging voltage of the load port 315. Additionally, in situations where voltage converter 325 is not necessary (e.g., batteries of equal voltage on connected to the wired adapter 300), the controller may toggle a switch to allow power to directly transfer from the source port 310 to the load port 315 without using the voltage converter 325.

Additionally, the controller 330 includes combinations of hardware and software that are operable to, among other things, control the operation of the battery packs 100A, 100B, 100C, control the operation of the voltage ports 105A, 105B, 105C, control the operation of the wireless communication controller 340, monitor a condition of the source battery packs 100A, 100B, 100C and load battery packs 100A, 100B, 100C, and respectively enable or disable charging of the source battery packs 100A, 100B, 100C and load battery packs 100A, 100B, 100C, etc.

The controller 330 includes a plurality of electrical and electronic components that provide power, operational control, and protection to the components and modules within the controller 330 and/or the wired adapter 300. For example, the controller 330 includes, among other things, a processing unit 355 (e.g., a microprocessor, a microcontroller, an electronic processor, an electronic controller, or another suitable programmable device), a memory 360, input units 365, and output units 370. The processing unit 355 includes, among other things, a control unit 375, an arithmetic logic unit (“ALU”) 380, and a plurality of registers 385 (shown as a group of registers in FIG. 3B), and is implemented using a known computer architecture (e.g., a modified Harvard architecture, a von Neumann architecture, etc.). The processing unit 355, the memory 360, the input units 365, and the output units 370, as well as the various modules or circuits connected to the controller 330 are connected by one or more control and/or data buses (e.g., common bus 390). The control and/or data buses are shown generally in FIG. 3B for illustrative purposes. The use of one or more control and/or data buses for the interconnection between and communication among the various modules, circuits, and components would be known to a person skilled in the art in view of the embodiments described herein.

The memory 360 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 355 is connected to the memory 360 and executes software instructions that are capable of being stored in a RAM of the memory 360 (e.g., during execution), a ROM of the memory 360 (e.g., on a generally permanent basis), or another non-transitory computer readable medium such as another memory or a disc. Software included within the memory 360 is operable to control the voltage converter 325, the wireless communication controller 340, the user interface 345, etc., and can be stored in the memory 360 of the controller 330. The software includes, for example, firmware, one or more applications, program data, filters, rules, one or more program modules, and other executable instructions. The controller 330 is configured to retrieve from the memory 360 and execute, among other things, instructions related to the control processes and methods described herein. In other constructions, the controller 330 includes additional, fewer, or different components.

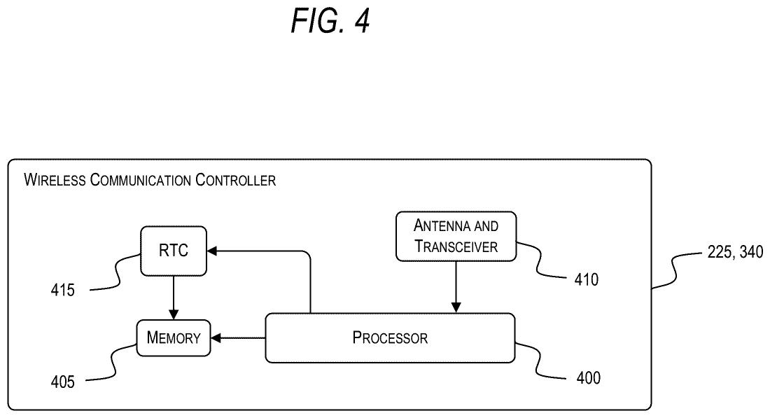

FIG. 4 illustrates the wireless communication controller 225, 340 for the battery packs 100A, 100B, 100C and the wired adapter 300. The wireless communication controller 225, 340 includes a processor 400, a memory 405, an antenna and transceiver 410, and a real-time clock (RTC) 415. The wireless communication controller 225, 340 enables the battery packs 100A, 100B, 100C and the wired adapter 300 to communicate with an external device (see FIG. 5). The radio antenna and transceiver 410 operate together to send and receive wireless messages to and from the external device and the processor 400. The memory 405 can store instructions to be implemented by the processor 400 and/or may store data related to communications between the battery packs 100A, 100B, 100C, the wired adapter 300, and the external device, or the like. The processor 400 for the wireless communication controller 225, 340 controls wireless communications between the battery packs 100A, 100B, 100C, the wired adapter 300 and the external device. For example, the processor 400 associated with the wireless communication controller 225, 340 buffers incoming and/or outgoing data, determines the communication protocol and/or communicates with the controller 200, 330, and determines the communication protocol and/or settings to use in wireless communications. The communication via the wireless communication controller 225, 340 can be encrypted to protect the data exchanged between the battery packs 100A, 100B, 100C, and the wired adapter 300 can be encrypted to protect the data exchanged between the battery packs 100A, 100B, 100C, the wired adapter 300, and the external device from third parties.

In the illustrated embodiment, the wireless communication controller 225, 340 is a Bluetooth® controller. The Bluetooth® controller communicates with the external device employing the Bluetooth® protocol. Therefore, in the illustrated embodiment, the external device and the battery packs 100A, 100B, 100C and/or the wired adapter 300 are within a communication range (e.g., in proximity) of each other while they exchange data. In other embodiments, the wireless communication controller 225, 340 communicates using other protocols (e.g., Wi-Fi, ZigBee, a proprietary protocol, etc.) over different types of wireless networks. For example, the wireless communication controller 225, 340 may be configured to communicate via Wi-Fi through a wide area network such as the Internet or a local area network, or to communicate through a piconet (e.g., using infrared or NFC communications).

In some embodiments, the network is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, 4GSM network, a 4G LTE network, 5G New Radio, a Digital AMPS (“IS-136/TDMA”) network, or an Integral Digital Enhanced Network (“iDEN”) network, etc.

The RTC 415 increments and keeps time independently of the other components. Having the RTC 415 as an independently powered clock (e.g., by coin cell battery) can enable, for example, time stamping of operational data (stored in memory 405 for later export).

FIG. 5 illustrates a communication system 505. The communication system 505 includes the battery packs 100A, 100B, 100C, the wired adapter 300, and the external device 500. Each battery pack 100A, 100B, 100C, wired adapter 300, and external device 500 can communicate wirelessly while they are within a communication range of each other. Each battery pack 100A, 100B, 100C and wired adapter 300 may communicate status, operation statistics, identification, sensor data, usage information, maintenance data, and the like.

Using the external device 500, a user can access operational parameters of the battery packs 100A, 100B, 100C and the wired adapter 300. With the parameters (e.g., battery voltage, charge level, etc.), a user can select a charge characteristic (e.g., output power level, input power level, etc.) for the wired adapter 300. The external device 500 can also transmit data to the wireless communication controller 225, 340 for charger configuration, firmware updates, or to send commands. The external device 500 also allows a user to set operational parameters, safety parameters, select other operational modes, and the like for the battery packs 100A, 100B, 100C and wired adapter 300.

The external device 500 is for example, a smart phone (as illustrated), a laptop computer, a tablet computer, a personal digital assistant (PDA), or another electronic device capable of communication wirelessly with the battery pack 100A, 100B, 100C and wired adapter 300 and providing a user interface. The external device 500 provides a user interface and allows a user to access and interact with the wired adapter 300, interact with the battery packs 100A, 100B, 100C, enable or disable features, and the like. The user interface of the external device 500 provides an easy-to-use interface for the user to control and customize operation of the wired adapter 300. The external device 500, therefore, grants the user access to the operational data of the battery pack 100A, 100B, 100C, and wired adapter 300, and provides a user interface such that the user can interact with the respective wireless communication controller 225, 340.

In addition, as shown in FIG. 5, the external device 500 can also share operational data obtained from the battery packs 100A, 100B, 100C and wired adapter 300 with a remote server 510 connected through a network 515. The remote server 510 may be used to store the operational data obtained from the external device 500, provide additional functionality and service to the user, or a combination thereof. In some embodiments, storing the information on the remote server 510 allows a user to access the information from a plurality of different locations. In some embodiments, the remote server 510 collects information from various users regarding their devices and provide statistics or statistical measures to the user based on information obtained from the different devices. The network 515 may include various networking elements (routers 520, hubs, switches, cellular towers 525, wired connections, wireless connections, etc.) for connecting to, for example, the Internet, a cellular data network, a local network, or a combination thereof as previously described.

FIG. 6 illustrates an exemplary interface 600 of the external device 500 for selecting a charge mode for the wired adapter 300 and/or the battery packs 100A, 100B, 100C. In the illustrated embodiment, a wired charging mode 605, a wireless charging mode 610, a on/off charge button 615, and a charge rate slider 625 can be selected and manipulated by a user. In some embodiments, configurable (e.g., a charge information window 620) operational modes are available. In other embodiments, the interface 600 may include additional information for the battery packs 100A, 100B, 100C (e.g., voltage, state of charge, temperature, etc.), and may allow for limited operational control (e.g., enabling and disabling the charging circuits of the battery packs). In some embodiments, the interface 600 can be used to select output charging voltages of the battery packs.

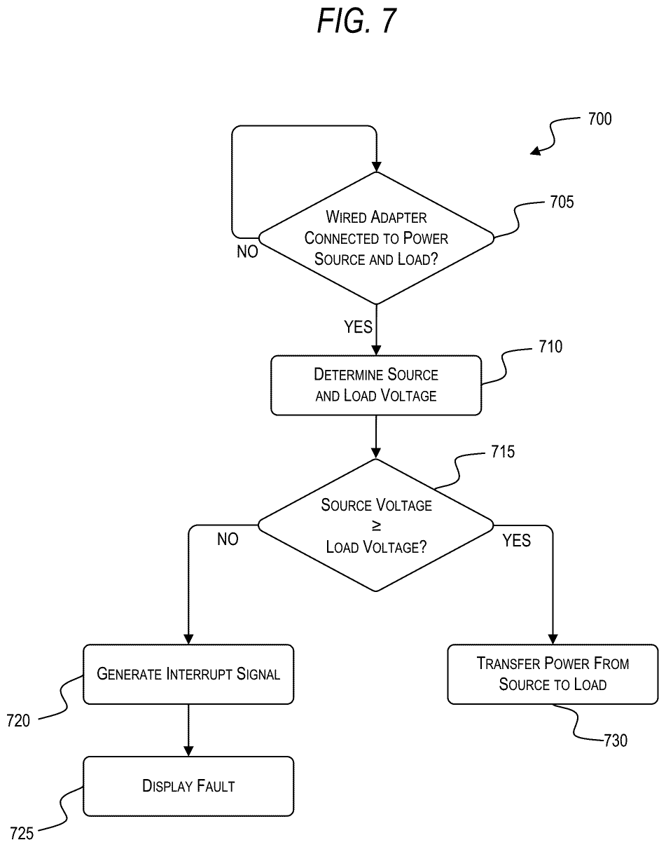

FIG. 7 is a process 700 for operating the controller 340 of the wired adapter 300. The process 700 begins with determining if the wired adapter 300 is connected to a power source and load (STEP 705). The power source is, for example, a battery pack 100A, 100B, 100C connected to the source port 310, and the load is, for example, a battery pack 100A, 100B, 100C connected to the load port 315. The monitoring of a parameter can be performed by the controller 340 of the wired adapter through the communications circuit 320 (e.g., to detect a presence, a voltage, or communication with a battery pack). If, at STEP 710, the wired adapter 300 is connected to a power source and load, the adapter determines the source voltage and the load voltage (STEP 710). If the wired adapter 300 is not connected to a power source and load, the process 700 continues to monitor the parameter of STEP 705. The wired adapter 300 may determine the source voltage of the power source by receiving a signal through the wireless communication controller 225, 340, through a signal sent through the universal connector 305, through the sensors 350 connected to the controller 340 of the wired adapter 300, etc. The process 700 then determines if the source voltage is greater than or equal to the load voltage (STEP 715). If the source voltage is not greater than or equal to the load voltage, the process 700 will generate an interrupt signal (STEP 720) and display a fault (STEP 725). If the source voltage is greater than or equal to the load voltage, the controller controls the voltage converter to transfer power from the source to the load (STEP 730). The controller 330 of the wired adapter 300 may determine the relationship between the source voltage and the load voltage using the controller 330. The power transfer from the source to the load may be done by communicating with the source battery packs 100A, 100B, 100C and the load battery packs 100A, 100B, 100C to respectively control discharging power and charging power, and by equalizing the voltages of the source battery packs 100A, 100B, 100C and the load battery packs 100A, 100B, 100C using the voltage converter 325. In some embodiments, a source voltage lower than the load voltage can be used to charge the load battery packs 100A, 100B, 100C. In such embodiments, for example, the voltage converter 325 can be configured as a step-up or boost converter.

FIG. 8 illustrates a wireless charging configuration 800 between two battery packs 100A, 100B, 100C. As previously shown, the battery packs 100A, 100B, 100C may include the transceiver 220 to wirelessly transfer power to another device. In the illustrated system, the source battery packs 100A, 100B, 100C include a controller 805 connected to a switch 810 and a transmitter 815. The switch 810 is operated such that the source battery cells 820 transmit power through the transmitter 815 to the receiver 825 of the load battery packs 100A, 100B, 100C serving as the load. The receiver 825 of the load battery packs 100A, 100B, 100C is controlled by an associated controller 830 and is electrically connected to a rectifier and filter circuit 835 before the load battery cells 840 are charged. The transmitter 815 and receiver 825 may be separate components in the battery packs 100A, 100B, 100C or may be incorporated into a single transceiver (e.g., transceiver 220), as previously described. The transmitter 815 and receiver 825 may use a variety of wireless charging methods (e.g., inductive, capacitive, radio-frequency, etc.) and associated hardware or software. In other constructions, the wireless charging configuration 800 may include additional, fewer, or different components.

In some embodiments, the controller 805 of the source battery pack 100A, 100B, 100C may communicate with controller 830 of the load battery pack 100A, 100B, 100C. In some embodiments, communication may be aided by the wireless communication controller 225, 340, as described above. In some embodiments, either of the source battery packs 100A, 100B, 100C or the load battery packs 100A, 100B, 100C may be replaced with an appropriate wireless device such as a wireless charger or a device that utilizes wireless charging (e.g., a mobile phone, a laptop, etc.).

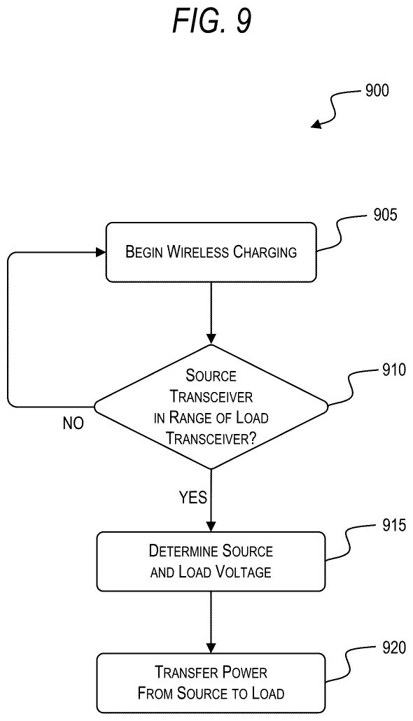

FIG. 9 illustrates a process 900 for the wireless charging configuration 800. The process 900 begins when the controller receives a signal to begin wireless charging (STEP 905). The process initiation could be automatically initiated by a controller 805, 830, a user interface, or via a wireless communication controller 225, 340. The process then determines if a source transceiver is in range of a load transceiver (STEP 910). If the source and load transceivers are in range, the controllers determine the voltages of the source and the load (STEP 915). The battery pack may determine the load voltage by receiving a signal through the wireless communication controller 225, 340, or through the sensors connected to the controller 805, 830 and transmitter 815 and/or the receiver 825. Once the voltages of the source and load are known, the transceiver is controlled to transfer power from the source to the load (STEP 920). In some embodiments, the transmitter 815 and/or the receiver 825 can include a voltage converter to step up or step down an available voltage for charging the load battery pack 100A, 100B, 100C.

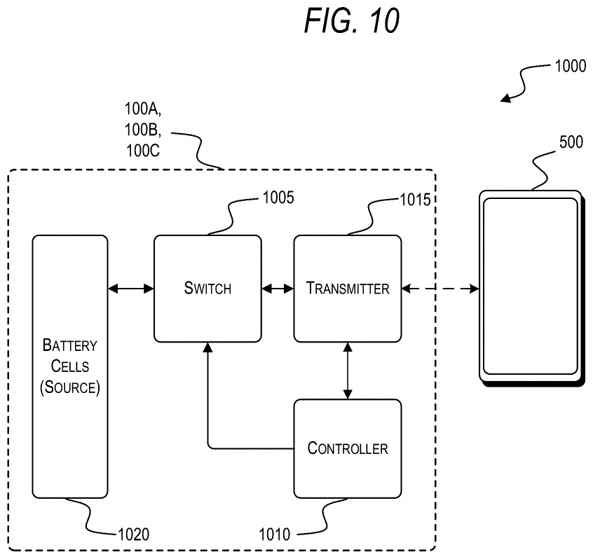

FIG. 10 illustrates a wireless charging configuration 1000 between the battery packs 100A, 100B, 100C and the external device 500. As previously shown, the battery packs 100A, 100B, 100C may include a transceiver 220 configured to wirelessly transfer power. In the illustrated system, the battery pack 100A, 100B, 100C includes a controller 1010 connected to a switch 1005 and a transmitter 1015. The switch 1005 is operated such that the source battery cells 1020 transmit power through the transmitter 1015 to the external device 500. The illustrated external device 500 is a mobile phone, however in other embodiments other external devices may receive power through the transmitter 1015 of the battery pack 100A, 100B, 100C if the external device has the correct hardware (e.g., a receiver, etc.).

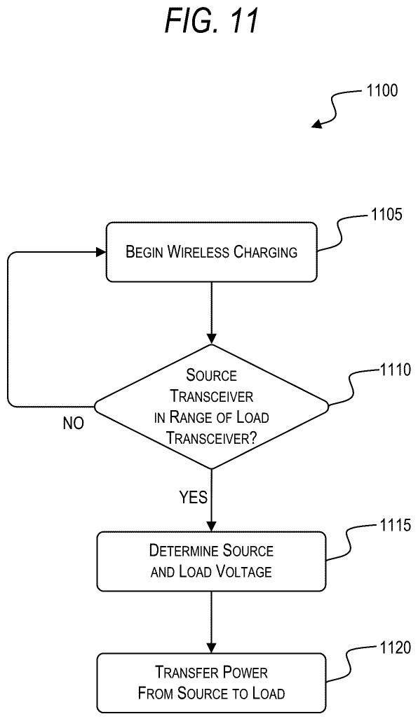

FIG. 11 illustrates a process 1100 for the wireless charging configuration 1000. The process 1100 begins when the controller receives a signal to begin wireless charging (STEP 1105). The process initiation could be automatically initiated by a controller 1010, a user interface, or via a wireless communication controller 225, 340. The process 1100 then determines if a source transceiver is in range of a load transceiver (STEP 1110). If the source and load transceivers are in range, the controllers determine the voltages of the source and the load (STEP 1115). The battery pack may determine the load voltage of the load by receiving a signal through the wireless communication controller 225, 340, or through sensors connected to the controller 1010 and transmitter 1015. Once the voltages of the source and load are known, the transceiver is controlled to transfer power from the source to the load (STEP 1120).

Although the invention has been described in detail with reference to certain embodiments, variations and modifications exist within the scope and spirit of one or more independent aspects of the invention as described.

Thus, embodiments described herein provide, among other things, battery pack to battery pack charging. Various features and advantages are set forth in the following claims.

What is claimed is:

1. A wired adapter connectable with a source battery pack and a load battery pack, the wired adapter comprising:
a source port connectable to the source battery pack, the source port configured to receive power from the source battery pack;
a load port connectable to the load battery pack, the load port configured to output a charging current to charge the load battery pack;
a voltage converter configured to receive the power from the source port and to output the charging current to the load port; and
an electronic controller configured to:
determine whether the source battery pack is connected to the wired adapter,
determine whether the load battery pack is connected to the wired adapter,
determine a source voltage associated with the source battery pack,
determine a load voltage associated with the load battery pack,
determine whether the source voltage is greater than or equal to the load voltage, and
transfer power from the source battery pack to the load battery pack when the source voltage is greater than or equal to the load voltage.

2. The wired adapter of claim 1, wherein the source battery pack is a power tool battery pack.

3. The wired adapter of claim 2, further comprising:
a connector removably coupled to a terminal of the source battery pack, the connector configured to connect the source battery pack to the source port.

4. The wired adapter of claim 1, wherein the voltage converter is a step-down voltage converter.

5. The wired adapter of claim 4, wherein the electronic controller is further configured to control a duty cycle of a source side switch of the voltage converter to step down the source voltage.

6. The wired adapter of claim 5, wherein the electronic controller is further configured to control a frequency of the voltage converter.

7. The wired adapter of claim 1, further comprising:
a wireless communication controller.

8. The wired adapter of claim 7, wherein the wireless communication controller is configured to receive a signal from an external device related to control of the wired adapter.

9. The wired adapter of claim 1, further comprising:
a first universal serial bus (“USB”) cable configured to be connected between the source port and the source battery pack; and
a second USB cable configured to be connected between the load port and the load battery pack.

10. The wired adapter of claim 1, wherein the wired adapter is configured to communicate with the source battery pack to receive information corresponding to the source voltage and communicate with the load battery pack to receive information corresponding to the load voltage.

11. A power tool battery pack comprising:
a housing;
a plurality of battery cells supported within the housing;
a tool terminal disposed on the housing and electrically connected to the plurality of battery cells;
a voltage output port electrically connected to the plurality of battery cells; and
an electronic controller configured to:
determine whether the voltage output port is electrically connected to an external load,
determine a load voltage associated with the external load,
determine whether a voltage of the plurality of battery cells is greater than or equal to the load voltage, and
transfer power from the plurality of battery cells when the voltage of the plurality of battery cells is greater than or equal to the load voltage.

12. The power tool battery pack of claim 11, further comprising:
a wireless communication controller.

13. The power tool battery pack of claim 12, wherein the wireless communication controller is configured to receive a signal from an external device related to control of the power tool battery pack.

14. The power tool battery pack of claim 11, wherein the power tool battery pack is configured to communicate with the external load to receive information corresponding to the load voltage.

15. The power tool battery pack of claim 11, wherein the voltage output port is a USB-C port.

16. A power tool battery pack comprising:
a housing including an interface configured to connect to a power tool;
a plurality of battery cells supported within the housing;
a source transceiver electrically connected to the plurality of battery cells, the source transceiver configured to wirelessly transfer power to an external device; and
an electronic controller connected to the source transceiver, the electronic controller configured to:
determine whether the source transceiver is within a power transfer range of a load transceiver of the external device,
determine a voltage of the plurality of battery cells,
determine a required voltage for charging the external device, and
transfer power from the source transceiver to the load transceiver if the voltage of the plurality of battery cells is greater than or equal to the required voltage for charging the external device.

17. The power tool battery pack of claim 16, further comprising:
a wireless communication controller.

18. The power tool battery pack of claim 17, wherein the wireless communication controller is configured to receive a signal from an external device related to control of the power tool battery pack.

19. The power tool battery pack of claim 18, wherein the electronic controller is further configured to control a charge rate when transferring power from the source transceiver to the load transceiver and wherein the charge rate is adjustable based on the signal from the external device.

20. The power tool battery pack of claim 16, wherein the source transceiver includes a switch configured to be controlled to control a power output of the source transceiver.
